(19) United States
(12) Patent Application Publication
(10) Pub. No.: US 2007/0040290 A1
(43) Pub. Date: Feb. 22, 2007

(54) Fixed moisture siphon-infiltration type honeycomb dehumidifying device

(76) Inventor: Wen-Feng Lin, Taipei City (TW)

Correspondence Address: TROXELL LAW OFFICE PLLC;SUITE 1404, 5205 LEESBURG PIKE, FALLS CHURCH, VA, 22041, US

(21) Appl. No.: 11/205,097

(22) Filed: Aug. 17, 2005

(51) Int. Cl. B01F 3/04

(52) U.S. Cl. 261/154; 261/112.2

(57) ABSTRACT

A dehumidifying device includes a casing that is divided into a dehumidification section and a regeneration section. A moisture-absorptive device made of fibrous material and pre-impregnated with liquid moisture-absorptive agent, is arranged inside the casing and extending between the dehumidification section and the regeneration section. A heater is disposed in an inlet port of regeneration section. When a wet airflow traveling along the dehumidification section passes through the moisture-absorptive device, the moisture is absorbed by the moisture-absorptive device and then spread into the regeneration section due to siphon effect caused by surface tension induced on the fibrous material. The moisture is then removed by an airflow traveling along the regeneration section and heated by the heater to complete the dehumidification operation.

### FIELD OF THE INVENTION

The present invention generally relates to a fixed moisture siphon-infiltration type honeycomb dehumidifying device, which is particularly suitable for applications where control of humidity is required.

### BACKGROUND OF THE INVENTION

In a humid area, such as an island, the humidity is often high all year round. Dehumidification is an important factor for industry in such an area. The operation of dehumidification is to remove moisture from air or other gas, making dry air or gas suitable for industry activity.

The most commonly known ways for dehumidification include:

(1) Cooling dehumidification: Air is cooled down to a temperature below the dew point and moisture contained in the air condenses into liquid water, which is then discharged. Dry air or air of lower humidity is thus obtained. The sources of cooling operation of air can use the coolant, iced water, or brine. However, the condensed water will get frozen on the surface of the cooling coil, if the surface temperature of the cooling coil gets lower than freezing point of water. This lowers the efficiency of cooling dehumidification, and makes it hard to maintain stable humidity. Generally, the temperature range for cooling dehumidification is between dew point and freezing point. For large facility of dehumidification, the amount of power consumed in the operation of the facility is increased and thus the operation costs are heightened.

(2) Compression dehumidification: Air is compressed first and then cooled down to condense moisture contained in the air to obtain a “drier” air containing less humidity. The condensed water is then discharged. Dehumidification facility of this type is only suitable for applications of low airflow rate, low dew point, and high-pressure air. In addition, the power consumption and thus costs for compression is relative high.

(3) Chemical-absorption dehumidification: Two sub-types of dehumidification, based on chemicals, are known, including (a) absorptive agent based intermittent process (tower type) and (b) liquid absorptive agent based process.

In respect of the absorptive agent based intermittent process, solid absorptive agent, such as silica gel, molecular sieve, active aluminum oxide, and zeolite, is filled in a tower as a fixing layer. Two towers are employed, of which one is for absorbing moisture, while the other for regeneration. After a certain time elapse, the towers are switched with each other and circulation of airflow is changed to switch the operation of moisture absorption and regeneration. This leads to intermittent supply of dehumidified air. The absorptive agent has a porous surface structure and moisture contained in the air is absorbed by the surface due to capillarity. This process, however, suffers for the switching operation between the dehumidification and regeneration in fixed time period and thus no continuous supply of dehumidified air can be affected. Also, it also requires replacement of the absorptive agent. In addition, dehumidification facility of this process has a significant pressure loss and a high regeneration temperature, which makes it only suitable for a closed loop operation.

In the liquid absorptive agent process, lithium chloride serves as the moisture absorptive agent. The facility is composed of dehumidifier, regenerator, and a circulation pump. When air contains moisture gets contact with sprayed liquid absorptive agent inside the dehumidifier, the moisture absorbed by the agent, thereby effecting dehumidification of the air. Heat released due to the absorption process is removed by cooling operation of a cooling coil. The agent that has absorbed moisture is circulated by the circulation pump to the regenerator in which the agent contacts regeneration air that has been heated by a heater and the moisture contained in the agent evaporates and entrains the regeneration air to the surrounding atmosphere. The concentration of the agent inside the regenerator is thus increased and is driven by the circulation pump back to the dehumidifier. This process allows for continuous operation of dehumidification and regeneration, resulting in stable supply of dehumidified air. However, the agent is in the form of mist when contacting the air, and the agent may entrain the air or splash, which consumes the agent. In addition, the concentration of the agent must be properly controlled in order to prevent damage caused on the circulation pump by the improper concentration of the agent, or blocking or jamming of associated nozzle. Thus, the costs for installation and maintenance are high.

Apparently, the conventional ways of dehumidification all suffers for complicated facility and high costs of manufacturing and maintenance. A honeycomb absorption type dehumidifier is developed to address the above problems. FIG. 8 of the attached drawings shows a conventional honeycomb dehumidifier, generally comprising a dehumidification rotor A, which is divided into a regeneration side A1 and a dehumidification side A2. The rotor A is coupled to and driven by a gear reducer B via a transmission belt B1. A heater C is arranged in front of the rotor A. When air contains moisture passes through the dehumidification side A2 of the rotor A, the moisture contained in the air is absorbed by the dehumidification side A2 of the rotor A and dehumidified or dry air is obtained. The dehumidification side A2 that has absorbed moisture is then driven by the gear reducer B through the belt B1 to rotate to the regeneration side A1 where it is subject to the heated airflow from the heater C and thus, the moisture is removed by entraining the hot airflow. The side of the rotor A, after processed by the hot airflow to remove the moisture, is rotated back to the dehumidification side A2.

Such a rotor device is capable of continuous dehumidification. However, power is required for rotation of the rotor. Thus, the device is not a fixed one, and additional power supply facility is required.

Thus, the present invention is aimed to provide a dehumidifying device that is low is cost and simple in construction to overcome the deficiency of the conventional devices.

### SUMMARY OF THE INVENTION

A primary objective of the present invention is to provide a fixed moisture siphon-infiltration type honeycomb dehumidifying device that is low in costs of manufacturing.

A secondary objective of the present invention is to provide a fixed moisture siphon-infiltration type honeycomb dehumidifying device that requires no switching between and rotation of dehumidification and regeneration means and thus having a simple construction.

To achieve the above objectives and in accordance with the present invention, a dehumidifying device comprising a casing that is divided into a dehumidification section and a regeneration section. A moisture-absorptive device made of fibrous material and pre-impregnated with liquid moisture-absorptive agent, is arranged inside the casing and extending between the dehumidification section and the regeneration section. A heater is disposed in an inlet port of regeneration section. When a wet airflow traveling along the dehumidification section passes through the moisture-absorptive device, the moisture is absorbed by the moisture-absorptive device and then spread into the regeneration section due to siphon effect caused by surface tension induced on the fibrous material. The moisture is then removed by an airflow traveling along the regeneration section and heated by the heater to complete the dehumidification operation.

### BRIEF DESCRIPTION OF THE DRAWINGS

The present invention will be apparent to those skilled in the art by reading the following description of preferred embodiments thereof, with reference to the attached drawings, in which:

FIG. 1 is a schematic view illustrating a dehumidifying device constructed in accordance with a first embodiment of the present invention;

FIG. 2 is a perspective view of a moisture-absorptive device of the dehumidifying device in accordance with the first embodiment of the present invention;

FIG. 3 is a schematic view illustrating a dehumidifying device constructed in accordance with a second embodiment of the present invention;

FIG. 4 is a perspective view of a moisture-absorptive device of the dehumidifying device in accordance with the second embodiment of the present invention;

FIG. 5 is a perspective view of a modification of the moisture-absorptive device of the dehumidifying device constructed in accordance with the second embodiment of the present invention;

FIG. 6 is a schematic view illustrating a dehumidifying device incorporating the modified moisture-absorptive device of FIG. 5;

FIG. 7 is a schematic view demonstrating the operation of the moisture-absorptive device of the present invention; and

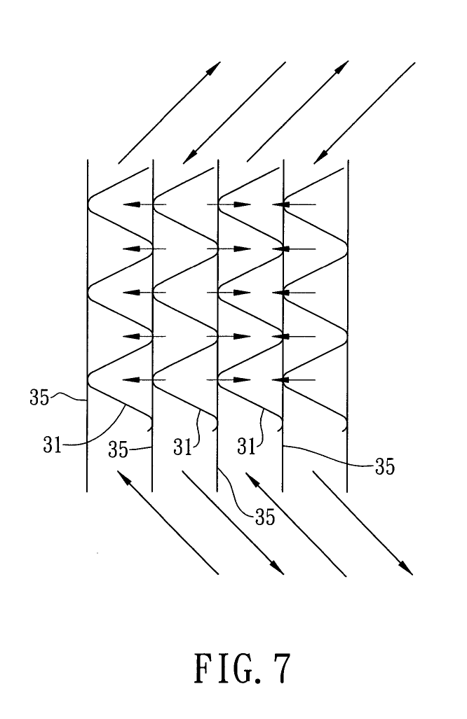

FIG. 8 is a perspective view illustrating a conventional dehumidification rotor.

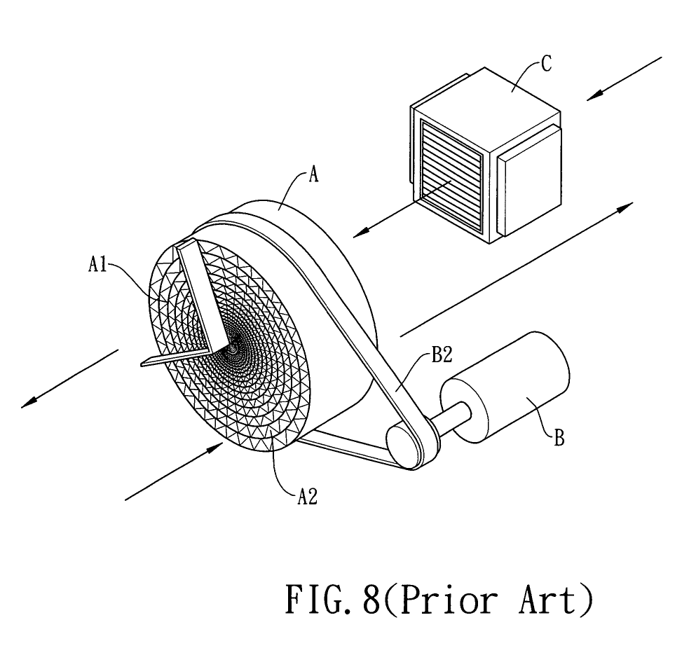

### DETAILED DESCRIPTION OF THE PREFERRED EMBODIMENTS

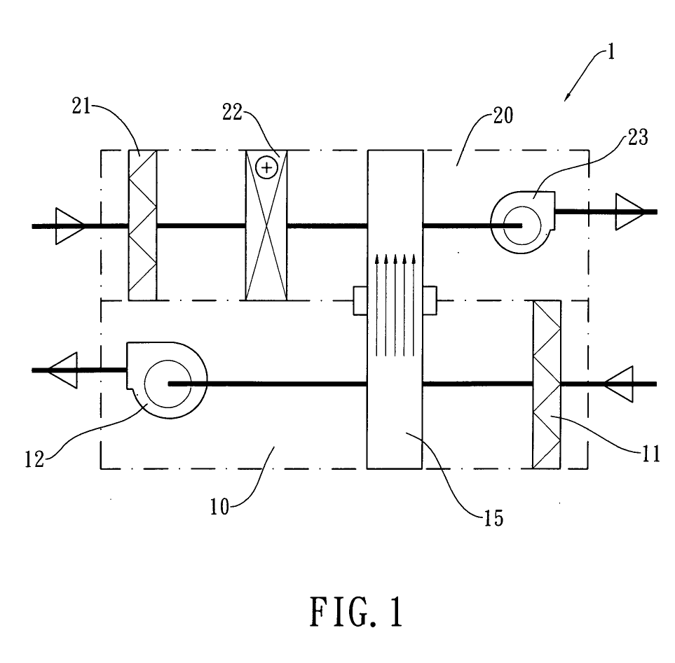

With reference to the drawings and in particular to FIG. 1, a dehumidifying device constructed in accordance with a first embodiment of the present invention comprises a casing 1 defining an interior space that is divided into a dehumidification section 10 and a regeneration section 20. A channel extends between the two sections 10, 20. The dehumidification section 10 forms an inlet port to which a primary filter screen 11 is mounted, and an opposite outlet port in which a blower 12 is mounted. Similarly, the regeneration section 20 forms an inlet port to which a primary filter screen 21 is mounted, and an opposite outlet port in which a blower 23 is mounted. A heater 22 is arranged behind the primary filter screen 21. A moisture-absorptive device 15 is arranged in the channel extending between the two sections.

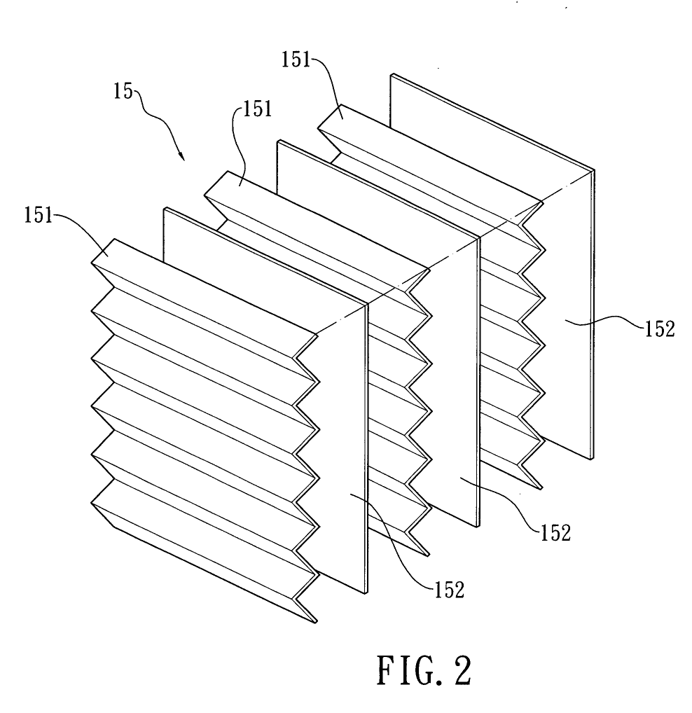

Also referring to FIG. 2, the moisture-absorptive device 15 is composed of a plurality of boards, made of fibrous material, stacked over each other. The boards include honeycomb boards 151 that form corrugations, and flat boards 152. In the embodiment illustrated, the corrugation of the honeycomb board 151 is of saw-tooth-shaped configuration. The honeycomb boards 151 and the flat boards 152 are pre-impregnated with liquid moisture-absorption agent. The honeycomb boards 151 and the flat boards 152 are alternately stacked with the saw-tooth configuration of the honeycomb boards 151 at the same orientation.

By supplying power to the dehumidifying device, the blowers 12, 23 and the heater 22 are actuated. Intake air that is to be dehumidified is taken into the casing 1 through the inlet port of the dehumidification section 10. The intake airflows through the primary filter screen 11 by which particles of large sizes and dust entraining the intake airflow are removed. The filtered airflow then passes through the moisture-absorptive device 15 by which moisture contained in the intake air is at least partially removed, resulting in the airflow of lower humidity, which will be referred to as “dry air” hereinafter. The dry air is then discharged.

Similarly, with the operation of the blower 23, external air from the surroundings is sucked into the regeneration section 20 through the primary filter screen 21 by which large particles and dusts are removed. The filtered air then heated by the heater 22. The heated air is then driven toward the moisture-absorptive device 15 of the regeneration section 20, which causes the moisture that is absorbed by the portion of the moisture-absorptive device 15 inside the dehumidification section 10 to spread toward the portion of the moisture-absorptive device 15 inside the regeneration section 20 due to siphon phenomena induced by the surface tension on each honeycomb board 151, thereby effecting dehumidification.

The moisture-absorptive device 15 is pre-impregnated in moisture-absorption agent to keep the surface of the boards 151, 152 wet, which maintains the infiltration of the moisture from the dehumidification section 10 to the regeneration section 20 without being interrupted by dryness of the boards 151, 152. Further, the moisture that is absorbed by the portion of the moisture-absorptive device 15 inside the regeneration section 20 is evaporated and thus removed by the hot airflow, which allows re-use of the moisture-absorptive device 15. This can also reduce the size of the casing 1, making the dehumidifying device suitable for household application or in-automobile applications.

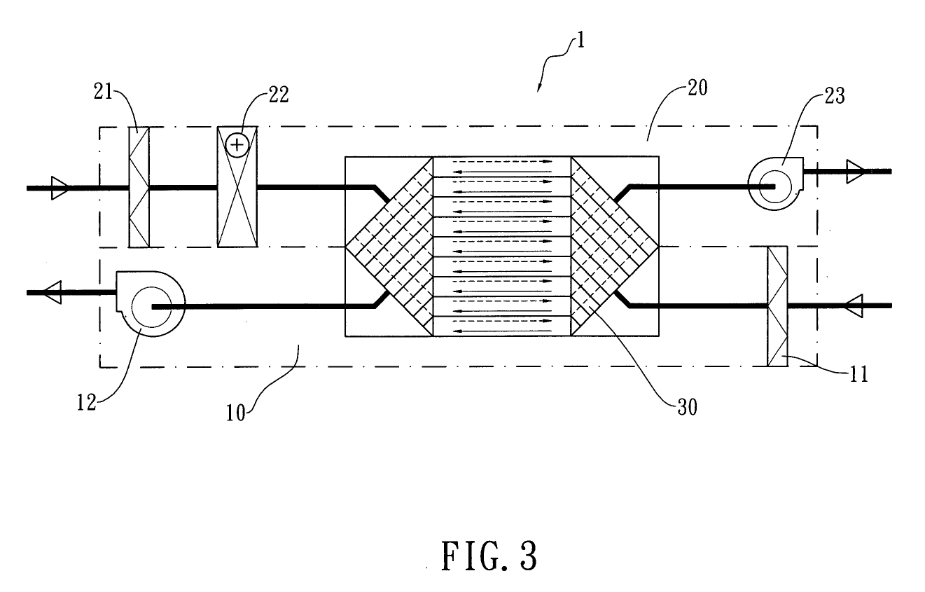

Referring to FIG. 3, which shows a second embodiment of the present invention, the casing 1 is again divided into a dehumidification section 10 and a regeneration section 20 between which a channel extends. The dehumidification section 10 has an inlet port to which a primary filter screen 11 is mounted, and an opposite outlet port in which a blower 12 is mounted. Similarly, the regeneration section 20 has an inlet port to which a primary filter screen 21 is mounted, and an opposite outlet port in which a blower 23 is mounted. A heater 22 is arranged behind the primary filter screen 21. A moisture-absorptive device 30 is arranged in the channel extending between the two sections 10, 20.

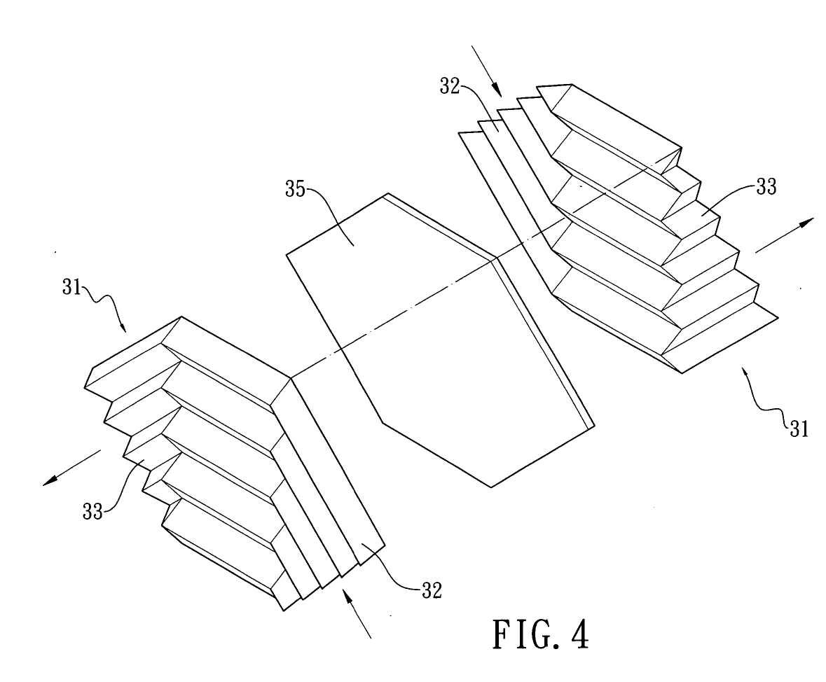

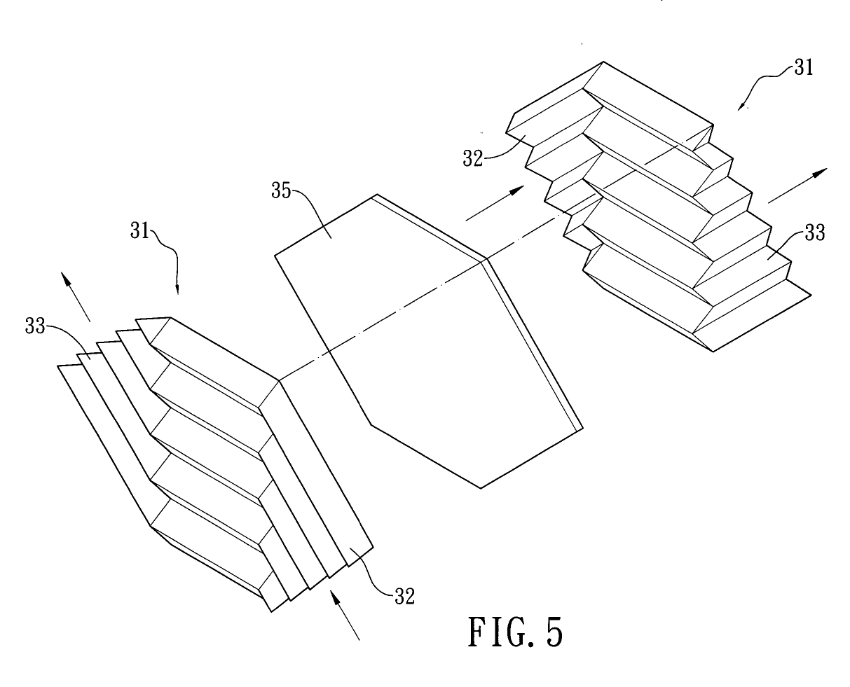

Also referring to FIG. 4, the moisture-absorptive device 30 is composed of a plurality of boards, made of fibrous material, stacked over each other. The boards include flat boards 35 and honeycomb boards 31 forming corrugations. The boards are of substantially the same size. The corrugation of the honeycomb board 31 comprises saw-tooth-like ridges and troughs, forming passages. The honeycomb board 31 has air inlet section 32 and air outlet section 33 which are on opposite sides of the honeycomb board 31 and are inclined for guiding air into and out of the passages of the honeycomb board 31. The inclination of the air inlet section 32 and that of the air outlet section 33 may be of the same direction, which means both inlet section 32 and the outlet section 33 facing the same side, as shown in FIG. 4, or the inclination of the air inlet section 32 and that of the air outlet section 33 are of opposite direction, which means the inlet section 32 and the outlet section 33 facing opposite sides, as shown in FIG. 5.

Referring to FIGS. 3 and 4, disposed inside the channel extending between the dehumidification section 10 and the regeneration section 20 of the casing 1 is the moisture-absorptive device 30. The moisture-absorptive device 30 is composed of a plurality of honeycomb board 31 and flat boards 35 stacked over each other in such an alternating manner that a flat board 35 is interposed between two honeycomb boards 31 and that the honeycomb boards 31 in front of and behind the flat boards are oriented in opposite directions. In other words, the honeycomb board 31 that is in front of the flat board 35 is of a regular direction, while the honeycomb board 31 behind the flat board 35 is of an opposite direction. In this way of arrangement, the air inlet section 32 and air outlet section 33 of the regular-direction honeycomb 31 are both facing the dehumidification section 10, while the air inlet section 32 and air outlet section 33 of the opposite-direction honeycomb 31 are both facing the regeneration section 20. Thus, the moisture-absorptive device 30 is of an arrangement that comprises alternating dehumidification layers and regeneration layers. Intake air to be dehumidified and external air for regeneration are counter flows with respect to each other. The spread of moisture inside the moisture-absorptive device 30 can be enhanced and thus the efficiency of moisture removal is increased.

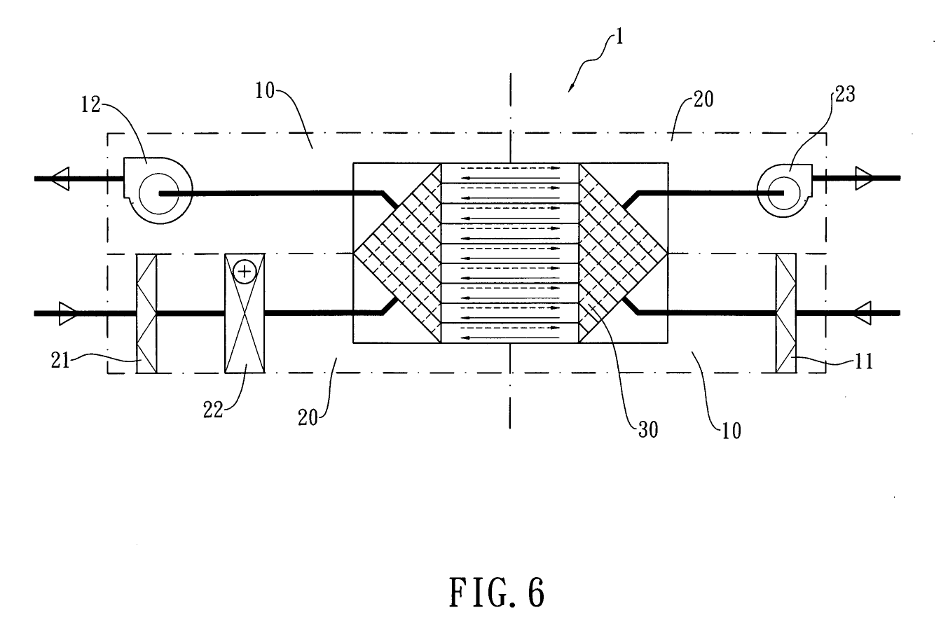

Further, referring to FIGS. 5 and 6, in this embodiment, the moisture-absorptive device 30 disposed inside the channel extending between the dehumidification section 10 and the regeneration section 20 is similarly composed of a plurality of honeycomb boards 31 and flat boards 35 stacked over each other. The boards are arranged in such a way that the honeycomb boards of regular direction and those of opposite directions alternate each other with a flat board 35 interposed between adjacent regular-direction honeycomb board 31 and opposite-direction honeycomb board 31. However, the air inlet section 32 and air outlet section 33 of the honeycomb board 31 are facing opposite directions. In other words, the air inlet section 32 of the regular-direction honeycomb board 31 faces a first portion of the dehumidification section 10 that is located at right lower side of the drawing page of FIG. 6, while the air outlet section 33 faces a second portion of the dehumidification section 10 located at left upper side of the drawings page. The first and second portions form the complete arrangement of the dehumidification section 10. Similarly, the air inlet section 32 of the opposite-direction honeycomb board 31 faces a first portion of the regeneration section 20 that is located at left lower side of the drawing page of FIG. 6, while the air outlet section 33 faces a second portion of the regeneration section 20 located at right upper side of the drawings page. The first and second portions form the complete arrangement of the regeneration section 20. In this way, the dehumidification section 10 and the regeneration section 20 are separated into four sub-sections or portions to accommodate the arrangement of the moisture-absorptive device 30. The primary filter screens 11, 21 are arranged in the inlet ports of the dehumidification section 10 and the regeneration section 20 that are located at the lower side of the drawing page of FIG. 6, while the blowers 12, 23 are arranged in the outlet ports of the dehumidification section 10 and the regeneration section 20 that are located at the upper side of the drawing page. The heater 22 is arranged inside the regeneration section 22 behind the primary filter screen 21.

The fixed moisture siphon-infiltration type honeycomb dehumidifying device has at least the following advantages:

(1) Only one fixed moisture-absorptive device is required. No switching between dehumidification and regenerator in fixed time period is needed and no power consumption for moving or rotating the moisture-absorptive device is required. Thus, the manufacturing costs are significantly reduced.

(2) The moisture-absorptive device is separated into a dehumidification-side portion and a regeneration-side portion. The regeneration-side portion is subject to continuous hot airflow, making the moisture that is absorbed in the dehumidification-side portion continuously spread to the regeneration-side portion by means of siphon effect. Thus, continuous operation of dehumidification can be realized.

(3) The dehumidifying device has a simple construction due to simplified components and the manufacturing costs, as well as maintenance costs, are reduced. The device can be used in household and in-car applications.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A dehumidifying device comprising:
a casing that is divided into a dehumidification section and a regeneration section;
a moisture-absorptive device made of fibrous material, arranged inside the casing and extending between the dehumidification section and the regeneration section; and
a heater disposed in an inlet port of regeneration section;
wherein by conveying a wet airflow containing moisture along the dehumidification section toward and through a first portion of the moisture-absorptive device inside the dehumidification section, the moisture is absorbed by the moisture-absorptive device;
wherein the moisture absorbed in first portion of the moisture-absorptive device is spread toward a second portion of the moisture-absorptive device inside the regeneration section due to siphon effect caused by surface tension induced on the fibrous material; and
wherein by conveying a second airflow through the heater, the second airflow is heated and the heated airflow is guided along the regeneration section toward and through the second portion of the moisture-absorptive device to remove the moisture spread to the second portion of the moisture-absorptive device.

2. The dehumidifying device as claimed in claim 1, wherein the moisture-absorptive device is pre-impregnated with liquid moisture-absorptive agent.

3. The dehumidifying device as claimed in claim 2, wherein the liquid moisture-absorptive agent comprises lithium chloride solution.

4. The dehumidifying device as claimed in claim 1, wherein the moisture-absorptive device comprises a plurality of boards made of ceramic fiber material, the boards comprising flat boards and honeycomb boards on which corrugation is formed.

5. The dehumidifying device as claimed in claim 4, wherein the corrugation of the honeycomb boards comprises a wavy configuration and wherein the honeycomb board comprises an inlet section and an outlet, which are on opposite sides of the honeycomb board and are inclined to guide airflow, and wherein in a stack formed by alternately overlapping the flat boards and the honeycomb boards, two adjacent honeycomb board is separated by a flat board and the honeycomb board in front of the flat board is oriented in a regular direction while the honeycomb board behind the flat board is oriented in an opposite direction, to respectively receive airflows of the dehumidification section and the regeneration section whereby wet airflow and heated airflow are directed in a counter flow fashion in the moisture-absorptive device.

6. The dehumidifying device as claimed in claim 5, wherein the inlet section and the outlet section of the honeycomb board are inclined toward the same direction.

7. The dehumidifying device as claimed in claim 5, wherein the inlet section and the outlet section of the honeycomb board are inclined toward opposite directions.
